(19) United States
(12) Patent Application Publication
(10) Pub. No.: US 2023/0144921 A1
(43) Pub. Date: May 11, 2023

(54) Novel String Trimmer Support

(71) Applicant: Gregory Wade Hoffmann

(72) Inventor: Gregory Wade Hoffmann

(21) Appl. No.: 17/521,822

(22) Filed: Nov. 8, 2021

(51) Int. Cl. A01D 34/84; A01D 34/416

(52) U.S. Cl. CPC A01D 34/84; A01D 34/416

(57) ABSTRACT

The present invention consists of a novel design of a lightweight string trimmer support intended to be positioned above the cutter head in a parallel plane to the plane of the rotating string generally consisting of an integral attachment device sized to fit string trimmer shafts both straight and curved and fastening to an angled or curved support arm to the string trimmer shaft with a wheel assembly connected to the opposite end of the attachment device configured so that the wheel is closely parallel to the plane of the string motion. The attachment device is design to allow for adjustments along the trimmer shaft for allow for proper positioning and well as allow for rotation adjustment to allow the wheel to be positioned at a slight planer angle to the string rotation plane to retard to the pull forces caused by the string trimmer impacting the surface at the string end.

### FIELD OF THE INVENTION

The present invention relates to a novel support system for string trimmers. More particularly, the invention relates to a string trimmer support system capable of supporting and positioning string trimmer cutting systems in various positions.

### BACKGROUND

String trimmers are a useful tool in grounds/vegetation management and beatification. However, string trimmers can be difficult to control when used for application/operations other that of an open field horizontal/parallel cutting (typical trimming) application.

When used in vertical trimming applications, such as edging, the weight of the trimmer and the reactionary forces the string imparts to the trimmers can make operating them difficult to control and produce desired results.

When string trimmers are used near/against vertical surfaces (or those perpendicular/non to the plane of the string rotation) in a horizontal application, maintaining proper distance so as to not damage the vertical surface can be difficult as well for the same reasons mentioned above.

One type of existing supports consists of a wheel attached to the grass deflector assembly. While this works on a few applications, it does not work well for many of the edging needs. As the wheel is meant to function from behind the cutter head, it does not work in both directions without relocating the wheel to the opposite side of the grass deflector assembly. Furthermore, this design does not provide for proper spacing for the rotating string and surfaces.

Other devices considered attachments to the shaft of string trimmer typically support the cutting head of the trimmer and positioned behind the cutting head for horizontal (parallel to the working surface/ground) applications and as such add a significant amount of weigh to the tool further making it difficult to manage in other cutting configurations and do not protect vertical surfaces.

Other remedies include using multiple machines; however, this is both more expensive, a waste of space, and more inefficient both in energy consumption and time.

The lack of control in the edging application contributes to poor quality of work (excessive cut out)

The lack of control requires slower operation increasing (wasting) energy consumption.

The lack of control also contributes to excessive line losses/wastes as the cutting line contacts unintended surfaces (typically concrete or asphalt).

Another difficulty in using string trimmers is gauging the operational string diameter leading to damage of vertical surfaces when operating the string trimmer in a horizontal mode. This is particularly problematic around small trees and shrubs as the string could cut into the bark and damage and possibly kill the tree/shrub. Likewise, on objects/surfaces such as posts and fences damage could be caused by the excessive impact of the tip of the string.

Lack of control in the various modes noted also contribute to safety issues. Undesirable or unintended impacts could lead to increased flying debris.

### BRIEF SUMMARY OF THE INVENTION

The present invention consists of a novel design of a lightweight string trimmer support intended to be positioned above the cutter head in a parallel plane to the plane of the rotating string generally consisting of an integral attachment apparatus sized to fit both straight and curved string trimmer shafts and fastening an angled or curved support arm to the string trimmer shaft with a wheel assembly connected to the opposite end of the attachment apparatus configured so that the wheel is closely parallel to the plane of the string motion. The attachment device is design to allow for adjustments along the trimmer shaft for allow for proper positioning and well as allow for rotation adjustment to allow the wheel to be positioned at a slight planer angle to the string rotation plane to retard to the pull forces caused by the string trimmer impacting the surface at the string end.

### BRIEF DESCRIPTION OF THE DRAWINGS

Some embodiments of the present invention are illustrated as an example and are not limited by the figures of the accompanying drawings, in which like references may indicate similar elements and in which:

FIG. 1A depicts an exploded perspective view of one example of a string trimmer support according to various embodiments of the present invention

FIG. 1B depicts an assembled perspective view of one example of a string trimmer support according to various embodiments of the present invention

FIG. 2 shows a side view perspective of one example of a string trimmer support according to various embodiments described herein.

FIG. 3 depicts a top view perspective of one example of the clamping apparatus according to various embodiments described herein.

FIG. 4 illustrates a side view perspective of one example of the assembled invention in perpendicular application (edging) relating to various embodiments described herein.

FIG. 5A illustrates a side view perspective of one example of the hinged apparatus according to various embodiments described herein.

FIG. 5B illustrates a side view perspective of one example of the hinged apparatus according to various embodiments described herein.

FIG. 10A illustrates a side view sketch of one example of a string trimmer support according to various embodiments described herein.

FIG. 10B illustrates a top (overhead) view sketch of one example of a string trimmer support according to various embodiments described herein.

FIG. 12 illustrates a side view perspective sketch of one example of a string trimmer support for curved shaft string trimmers according to various embodiments described herein.

FIG. 13 illustrates a side view perspective sketch of one example of the assembled invention in horizontal application (trimming) relating to various embodiments described herein.

FIG. 14 illustrates a top view perspective sketch of one example of the assembled invention configuration showing the wheel angle for torsion control relating to various embodiments described herein.

FIG. 15 illustrates a top view perspective sketch of one example of the assembled invention configuration showing the support arm offset relating to various embodiments described herein.

FIG. 16 illustrates a top view perspectives sketch of one examples of the assembled invention configuration showing multi wheel options relating to various embodiments described herein.

FIG. 17 illustrates a side view perspective sketch of one example of the assembled invention in perpendicular application (shrubbery bed edging) relating to various embodiments described herein.

FIG. 18 illustrates a side view perspective sketch of one example of the assembled invention configuration showing adjustment relating to changing attach angle of the string rotation relating to various embodiments described herein.

FIG. 19 illustrates a side view perspective sketch of one examples of the assembled invention configuration showing adjustment relating to changing the support arm angle relative to the string rotation relating to various embodiments described herein.

FIG. 20 illustrates a side view perspective sketch of one example of the assembled invention configuration showing a support arm bumper pad option relating to various embodiments described herein.

FIG. 21 illustrates a side view perspective sketch of one example of the assembled invention configuration showing clamping option for the support arm on the side of the string trimmer shaft option relating to various embodiments described herein.

FIG. 22 illustrates a side and top view perspective sketches of one example of the assembled invention configuration showing clamping option for the split support arm on the both sides of the string trimmer shaft option relating to various embodiments described herein.

FIG. 23 illustrates a side view perspective sketch of one example of the assembled invention configuration showing clamping option with retraction hinge option for the split support arm on the string trimmer shaft option relating to various embodiments described herein.

FIG. 24 illustrates a top and side view perspective sketch of one example of a welded (integral part to the string trimmer shaft) receiving bracket option relating to various embodiments described herein.

FIG. 25 illustrates a top view perspective sketch of one example of aa adjustable support arm option relating to various embodiments described herein.

### DETAILED DESCRIPTION OF THE INVENTION

The terminology used herein is for the purpose of describing particular embodiments only and not intended to be limiting of the invention. As used herein, the term and/or includes any and all combinations of one or more of the associated listed items. As used herein, the singular forms “a”, “an”, and “the” are intended to include the plural forms as well as the singular forms, unless the context clearly indicates otherwise. It will be further understood that the terms “comprises”, and/or “comprising,” when used in this specification, specify the presence of stated features, steps, operations, elements, and/or components, but do not preclude the presence or addition of one or more other features, steps, operations, elements, and/or components and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having the same meaning that is consistent with their meaning in the context of the relevant art and the present disclosure and will not be interpreted in an idealized or overly formal sense unless expressly so defined herein.

In describing the invention, it is understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of individual steps in an unnecessary fashion. Nevertheless, the specifications and claims should be read with the understanding that such combinations are entirely withing the scope of the invention and claims.

New string trimmer support devices, apparatuses, and methods for operating string trimmers are discussed herein. In the following description, for the purposes of explanation, numerous specific details are set forth in order to provide a thorough understating of the present invention. It will be evident, however, to one skill in the art that the present invention may be practiced without these specific details.

The present disclosure in to be considered as an exemplification of the invention and is not intended to limit the invention to the specific embodiments illustrated by the figures or descriptions below.

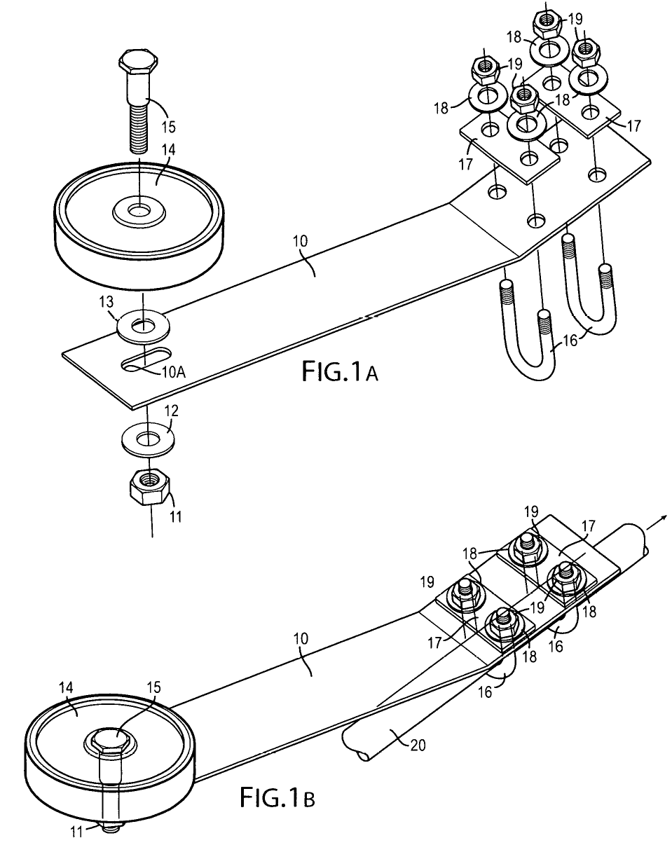

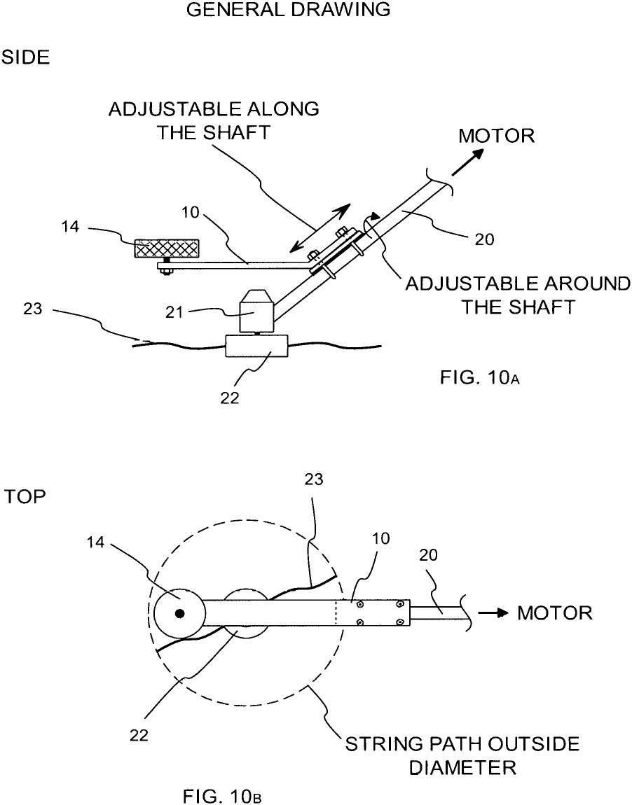

The present invention will now describe by referencing the appended figures representing preferred embodiments. FIG. 1A depicts an exploded perspective view of the elements that comprise a String Trimmer Support device (the “device”) according to various embodiments of the present invention. The device consists of a support arm 10, which is configured to accept a clamping or other securing device to a string trimmer shaft 20 (FIGS. 1B, 10A, 10B). While preferred material for support arm 10 is aluminum, other metals, metal alloys, plastics and other sufficiently rigid and appropriately flexible materials could be used. The support arm 10 may be solid or porous depending on material of choice. Structural holes can be included along the support arm 10 to reduce its weight while maintaining proper rigidity and flexibility. While a flexible/semi-rigid support arm 10 offers better control, stiffening/stiffeners such as folds, bends, creases in the support arm 10 can be added as desired. The support arm 10 may be of various lengths. The support arm 10 can be of various cross-section configurations both solid and hollow such as rectangular solid plate, square/rectangular tubing or round/oval tubing.

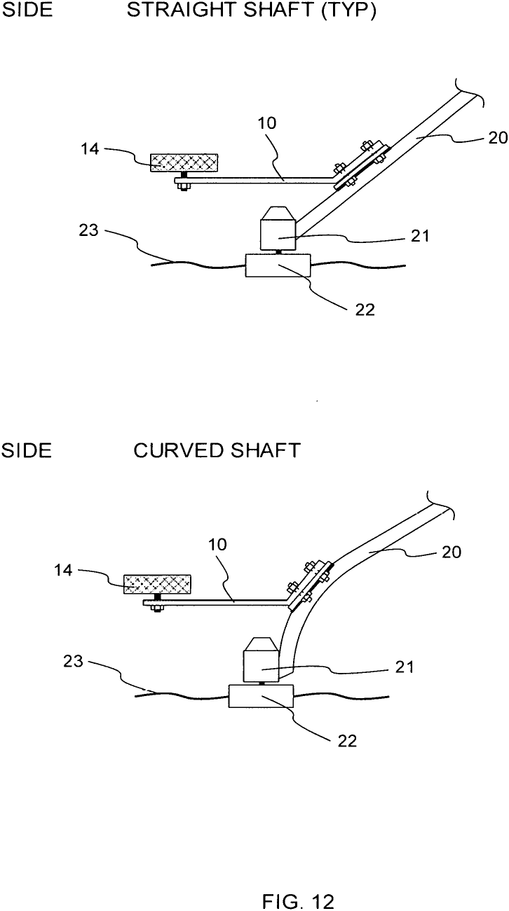

The clamping apparatus is configured with a clamping apparatus bracket (“U-bolt”) 16, clamping apparatus plate 17, clamping apparatus washers 18 and clamping apparatus nuts 19. The clamping device is configured to secure the support arm 10 to the string trimmer shaft 20. While typical threaded nuts are shown for the clamping apparatus nuts 19 sized for the clamping apparatus bracket (“U-bolt”) 16, these can be replaced with wing nuts, knobs, rotating knobs, lever style wing nuts, self-locking nuts, double nutting, cap nuts, or other threaded device. For illustrative purposes, a threading “U-bolt” type of clamping apparatus is shown: however, other types of clamping devices could be equally effective in securing the support arm 10 to the string trimmer shaft 20 such as quick release clamps, toggle clamps, quick lever clamp, seat post clamp - all types, saddle clamp, telescoping tube clamp, split pipe clamps, set screw clamps, set screws with integral bracket, etc. The functional diameter (interior diameter - ID) of the clamping device can vary to fit the functional diameter (exterior diameter - OD) of the of the string trimmer shaft 20. The clamping device/support arm 10 configuration can fit both straight and curved string trimmer shafts 20 (FIG. 12).

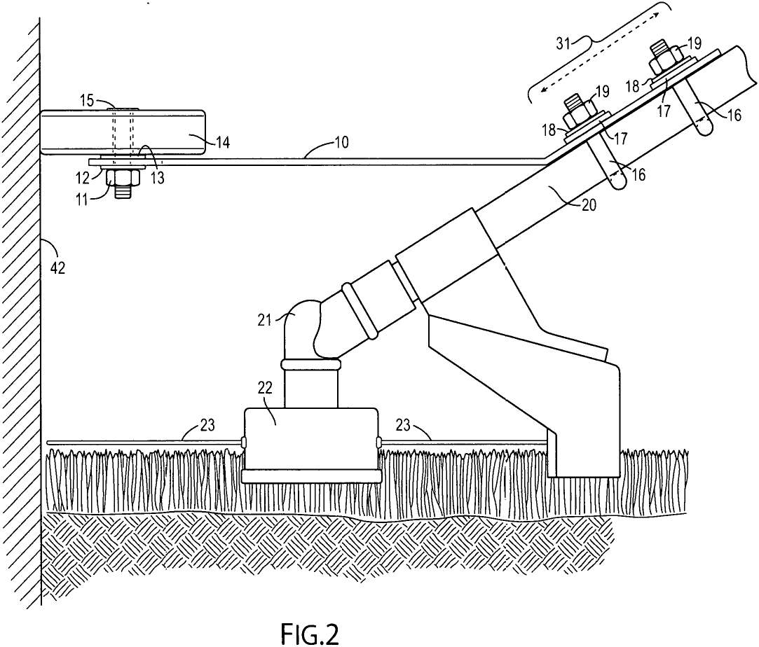

In certain applications, an integral part 50 could be prefabricated into or welded onto the string trimmer shaft 20 (replacing the clamping apparatus bracket [“U-bolt”] 16) to the string trimmer shaft to enable the support arm 10 to be attached. This part could be a plate which could include slots/multiple holes to ensure proper positioning/adjustment of the support arm 10 along 31 the string trimmer shaft 20 (FIG. 2). Other integral part 50 designs that could be integrated to the string trimmer shaft 20 include various tube shapes (sleeves) to receive corresponding shapes of the support arm 10. As with the clamping apparatus, the integral part 50 is designed to allow for adjustment of support arm 10 along 31 (FIG. 2) the string trimmer shaft 20 to allow for spacing between support arm 10 and string trimmer gear case 21 as well as positioning of the wheel 14 to provide proper spacing of the rotating string 23 diameter.

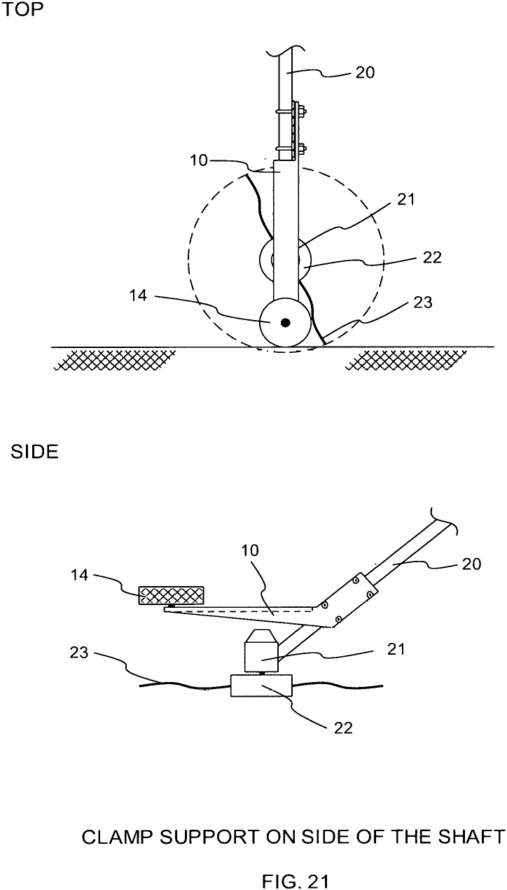

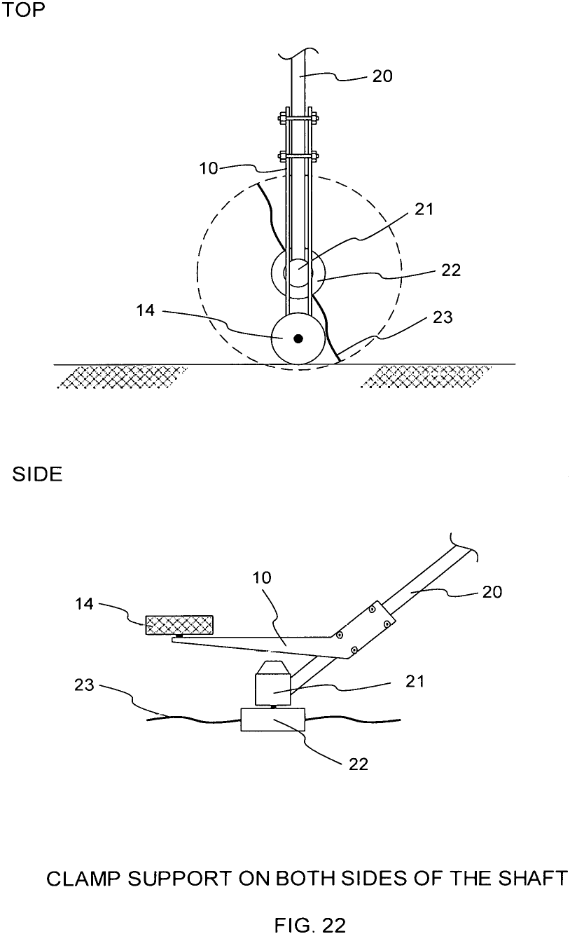

As the support arm 10 and the clamping device show the support arm 10 position on top of the string trimmer shaft 20 (FIGS. 1B, 2, 3, 4), The support arm 10 can also be attached to positions other than the top of the string trimmer shaft 20 such as the side or bottom FIG. 21 so long as the wheel 14 end of the support arm 10 positions the wheel 14, parallel or near parallel to the plane of the string trimmer sting 23 rotation. Additionally, the support arm 10 can be configured so that it attaches on both sides (serving as its own clamping device) of the string trimmer shaft 20 (FIG. 22) so long as the wheel 14 end of the support arm 10 positions the wheel 14, parallel or near parallel to the plane of the string trimmer sting 23 rotation.

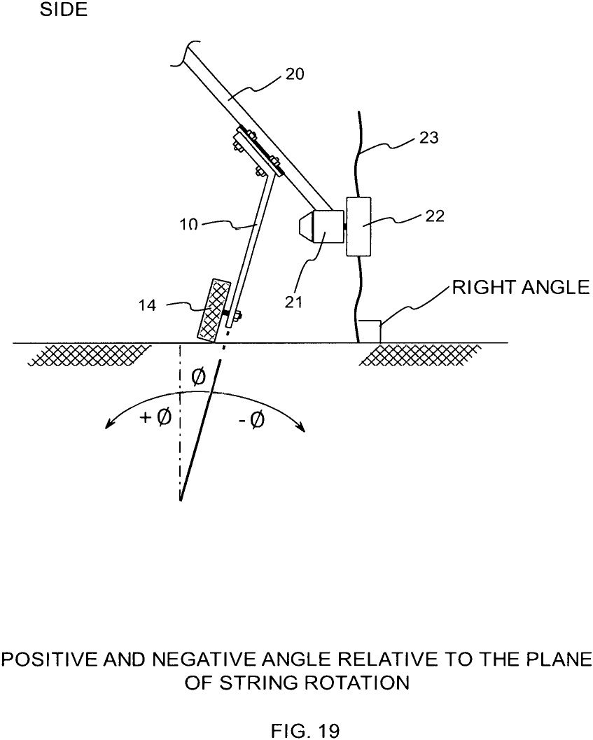

While the support arm 10 is shown in a parallel plane as the rotation of the string trimmer string 23 rotation (FIG. 2), it can also have an offset from the string trimmer string 23 rotation plane as shown in FIG. 19.

The support arm 10 is also configured to secure and position a wheel assembly. The wheel assembly consists of a wheel 14, and wheel axle 15, axle washer 13, axle nut washer 12 and a axle nut 11. Wheel axle 15 can be attached to the support arm 10 through either a single or multiple fixed holes or support arm slot 10A in the support arm 10 to provide for further adjustment as desired. The wheel 14 is meant to be free spinning by the means of a collared wheel axle 15. The wheel 14 can be placed on either side of support arm 10, on top (shown) or on the opposite side of the support arm 10 closer to the string trimmer gear case 21. While a threaded axle nut 11 is shown, this can be replaced with either a wing nut, knob, rotating knob, lever style wing nut, self-locking nut, double nutting, cap nut, etc. The wheel 14 can be of various diameters and thicknesses. The wheel 14 can be solid, spoked or other wheel configuration. The wheel 14 tread can be smooth or various knobbiness and tread configurations as desired. The preferred material for wheel 14 is lightweight plastic; however, other materials and combination of materials such as rubber, metal, metal alloys, foam can be used to function as a wheel 14. The axle washer 13 is configured to provide appropriate tolerances and support between the wheel axle 15 and the support arm 10 to allow the wheel 14 to spin freely. The axle nut washer 12 is configured to appropriate support between the support arm 10 and the axle nut 11.

While preferred material for the wheel axle 15, the axle washer 13, the axle nut washer 12, the axle nut 11, the clamping apparatus bracket (“U-bolt”) 16, the clamping apparatus plate 17, the clamping apparatus washers 18 and the clamping apparatus nuts 19 is steel, other metals, metal alloys, plastics and other sufficiently rigid materials could be used.

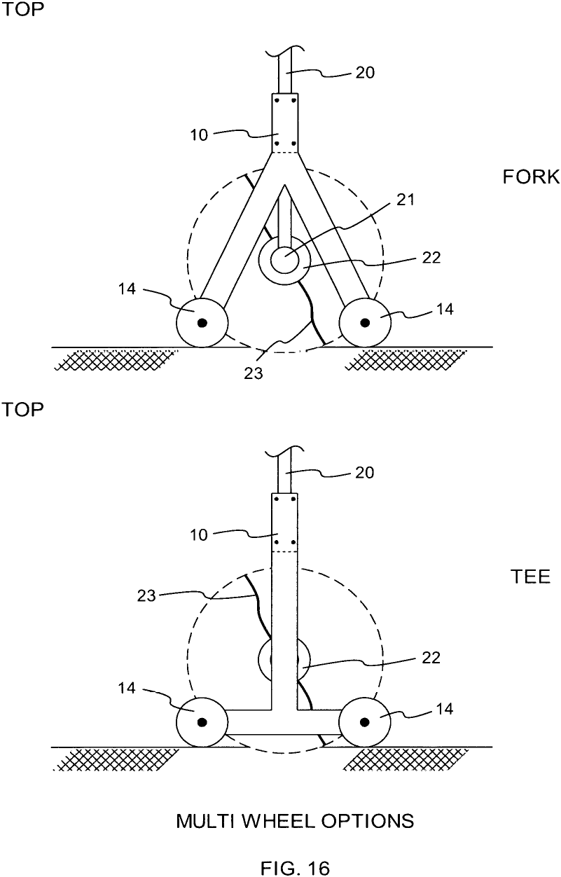

While a one wheel 14 configuration is shown (FIGS. 1A, 1B, 2, 3, 4), multiple wheel configurations (FIG. 16) are also acceptable. These could be configured with forked or tee shaped support arms 10.

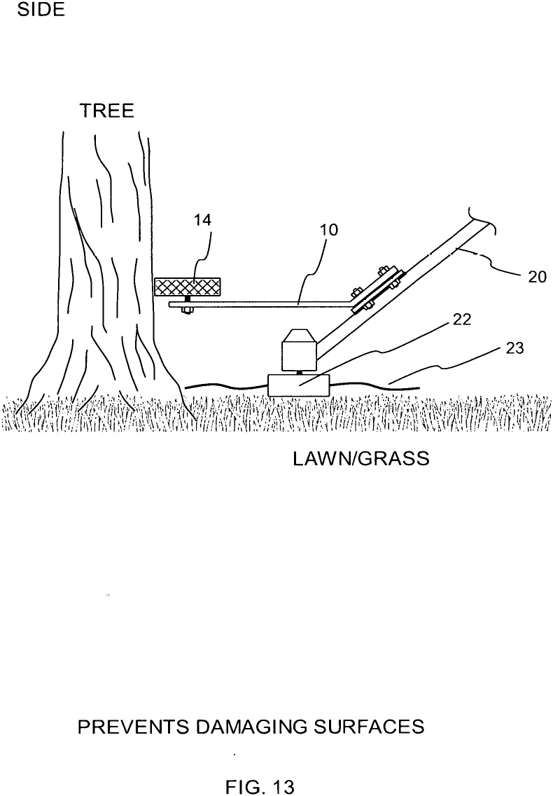

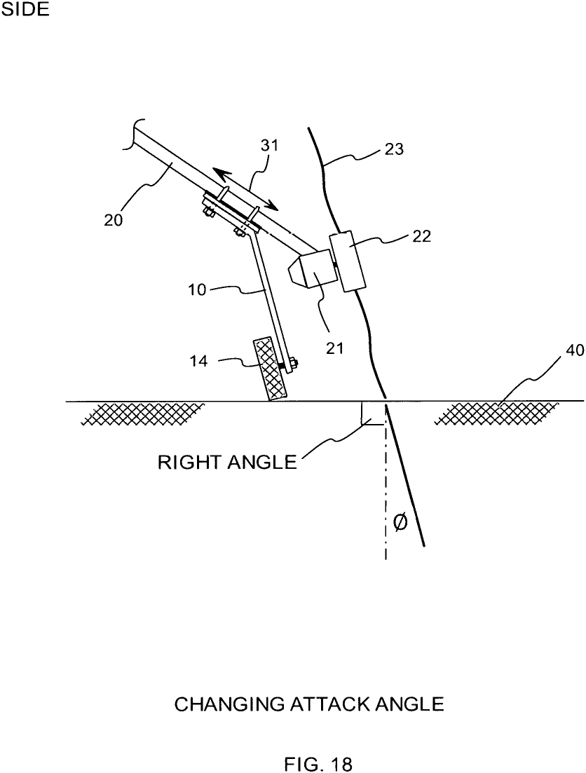

FIG. 2 shows a side view perspective of one example of a string trimmer support in a horizontal (parallel to the ground) application using the string trimmer support to properly distance the rotation of the string trimmer string 23 from a perpendicular surface 42. Perpendicular surfaces 42 may include fences, posts, trees (FIG. 13), walls and other rigid, soft, brittle, abrasive surfaces. Additionally, FIG. 2 shows how the clamping device can allow for travel 31 of the support arm 10 along the string trimmer shaft 20 to allow the string trimmer support to be adjusted as desired to position the wheel 14 relative to the proper clearance to the rotating string trimmer string 23. Further adjustment also offers the option to change the angle of attach (positive/negative angle relative to perpendicular) for the string trimmer string 23 rotation as shown in FIG. 18.

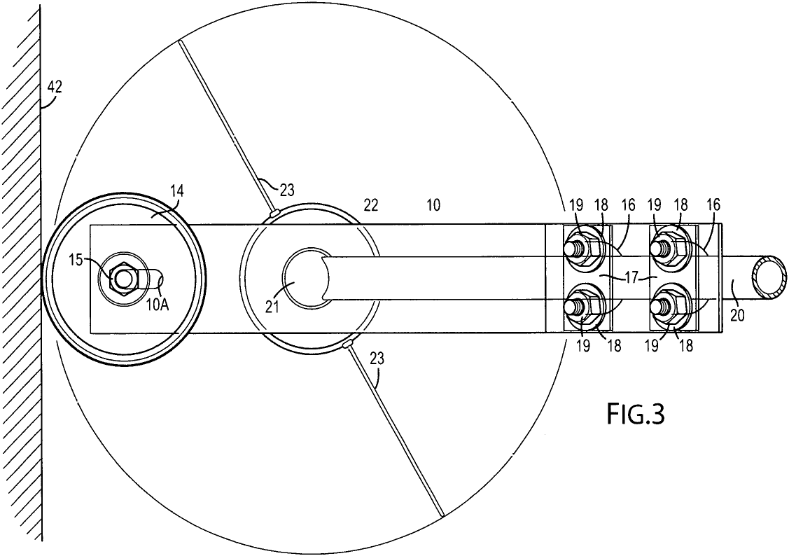

FIG. 3 depicts a top or front view perspective of how the string trimmer support positions the string trimmer cutter device to properly distance the rotating string trimmer string 23 from the perpendicular surface 42.

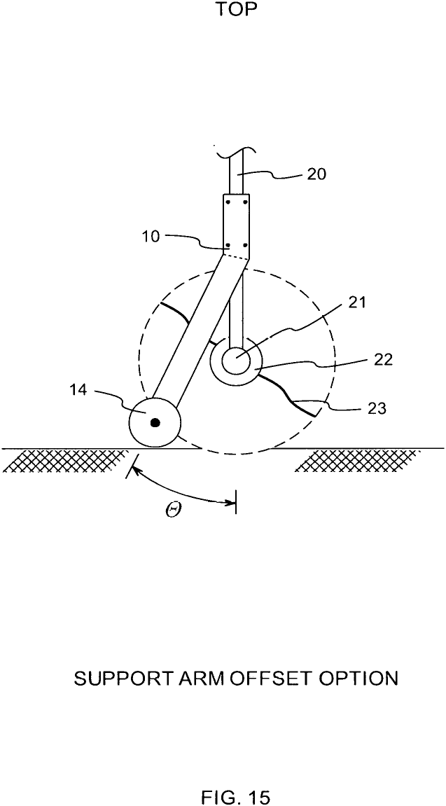

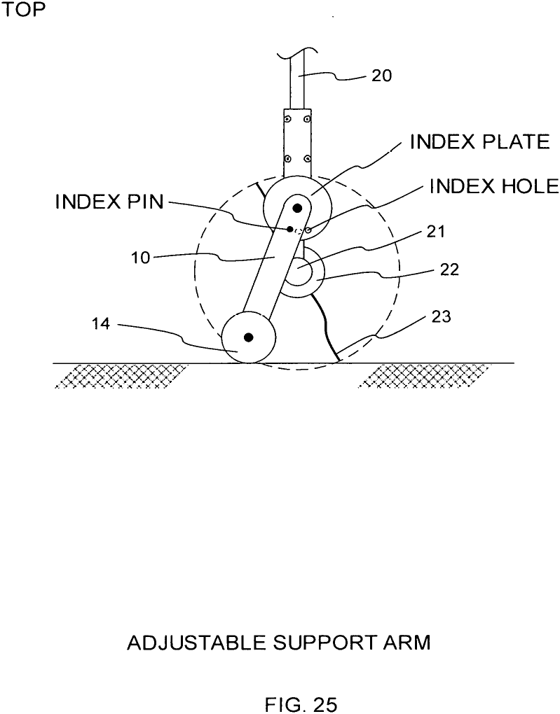

As FIG. 3 depicts a top or front view perspective of the device and that the string trimmer support is in line with the string trimmer shaft 20 including the support arm 10, the support arm 10 could be configured with an offset (FIG. 15) so that the wheel 14 either leads or trails the symmetry plane of the string trimmer shaft 20, string trimmer gear case 21 and the string trimmer string head 22. This angle could be adjustable by the means of an index plate with index pin (FIG. 25).

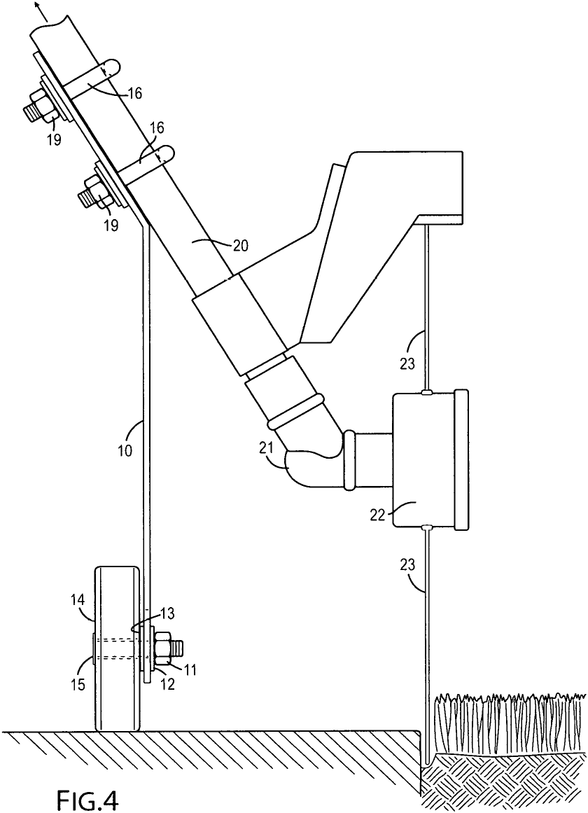

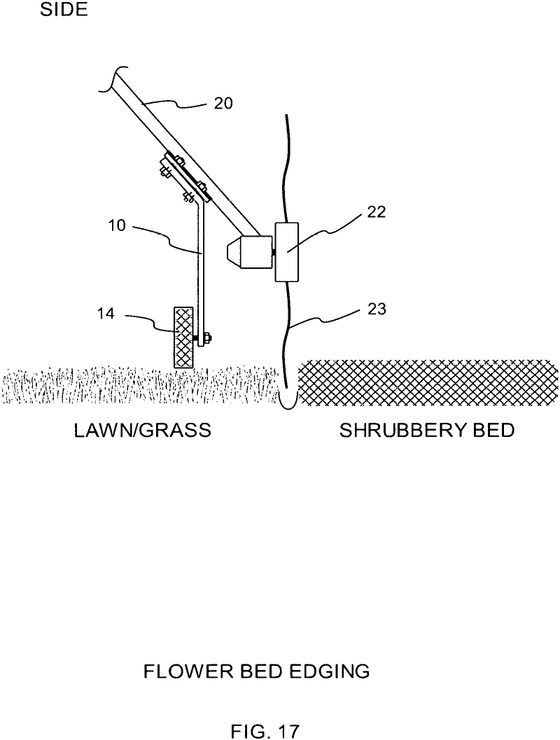

FIG. 4 illustrates a side view perspective of one example of a string trimmer support in a vertical (perpendicular to surface) edging application. This depicts the string trimmer support resisting the normal forces involved in using the string trimmer in an edging configuration. These forces include the weight of the string trimmer, the rotational forces applied by the rotating string trimmer string head 22 and string trimmer string 23 as well as impact forces transferred between solid surfaces 40 and soft surfaces 41 and the rotating string trimmer string 23. This support then allows for greater control of the entire string trimmer devices when used in this configuration. FIG. 17 illustrates this for shrubbery bed edging.

As FIG. 4 illustrates a side view perspective of one example of a string trimmer support in a vertical (perpendicular to surface) edging application and as the clamping device allows for adjustment along 31 the string trimmer shaft 20, the device can be adjusted in order to change the planer rotation of the string from perpendicular to the solid surface 40 either a slightly negative or positive angle from perpendicular (FIG. 18).

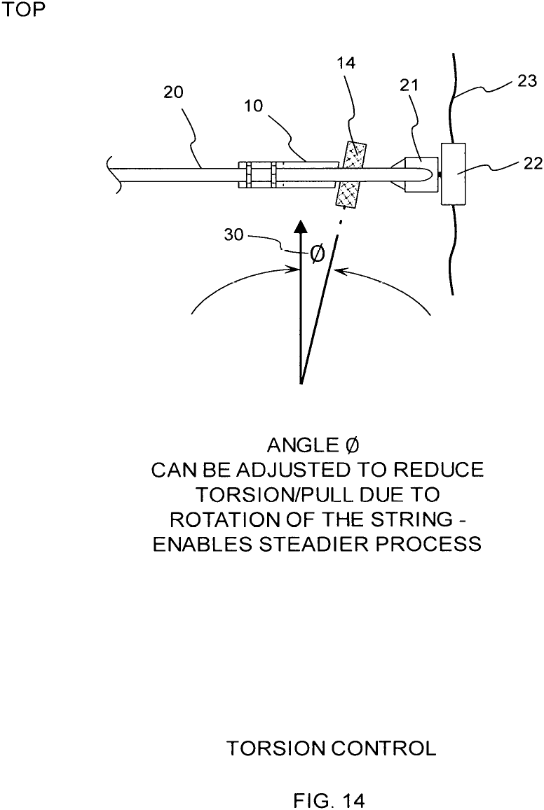

As FIGS. 2, 3 and 4 depict the device wheel 14 configuration in a parallel plane to the string trimmer string 23 rotation plane, the device can be adjusted to misalign the functional plane of the wheel 14 to the plane of the rotating string trimmer string 23 (FIG. 14) thereby imposing a resistance force to the forces imposed by the string trimmer string 23 rotation and string tip impact with surfaces. This offers torsional control (rotational forces about the string trimmer shaft 20).

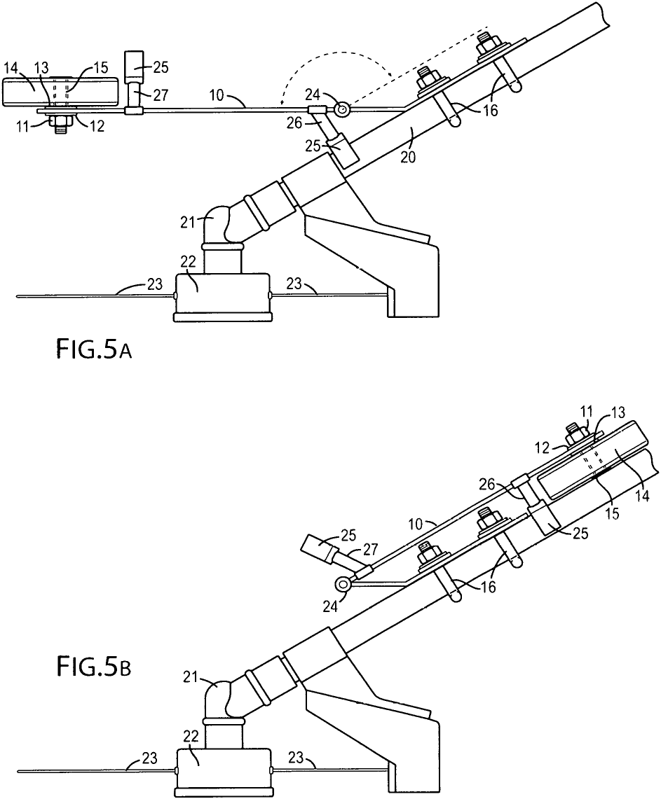

FIG. 5A depicts a side view of string trimmer support in an extended/functional manner showing further embodiments that could be integrated into the design include but are not limited to a support arm hinge 24 in the support arm 10 to allow the wheel 14 end to rotate from its functional (extended) position to a location along the string trimmer shaft 20 out of the way if clearance is needed above the string trimmer gear case 21 for certain trimming needs. A clipping system consisting of a string trimmer shaft clip 25 and an extended clip bracket 27 are used to maintain the string trimmer support in the functional position. While a clipping system is detailed, other securing devices could be used. The string trimmer shaft clip 25 is configured to correspond to the string trimmer shaft 23 diameter. The extended clip bracket 27 can be of various lengths.

FIG. 5B depicts a side view of string trimmer support in a retracted manner showing further embodiments that could be integrated into the design include but are not limited to a support arm hinge 24 in the support arm 10 to allow the wheel 14 end to rotate from its functional (extended) position to a retracted location along the string trimmer shaft 20 out of the way if clearance is needed above the string trimmer gear case 21 for certain trimming needs. A clipping system consisting of a string trimmer shaft clip 25 and a retracted clip bracket 26 are used to maintain the string trimmer support in the retracted position. While a clipping system is detail other securing devices could be used. The string trimmer shaft clip 25 is configured to correspond to the string trimmer shaft 23 diameter. The retracted clip bracket 26 can be of various lengths.

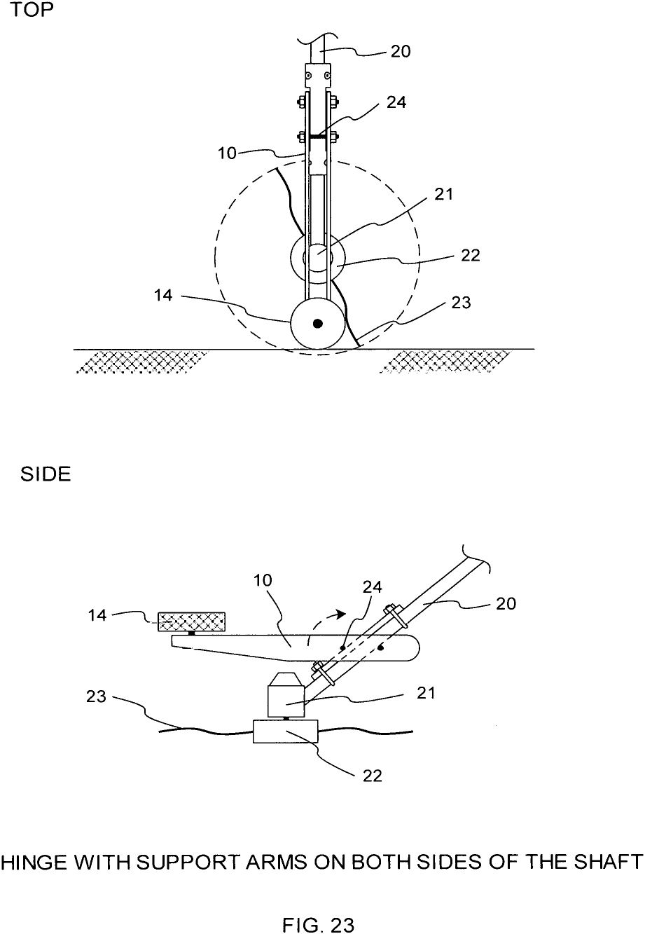

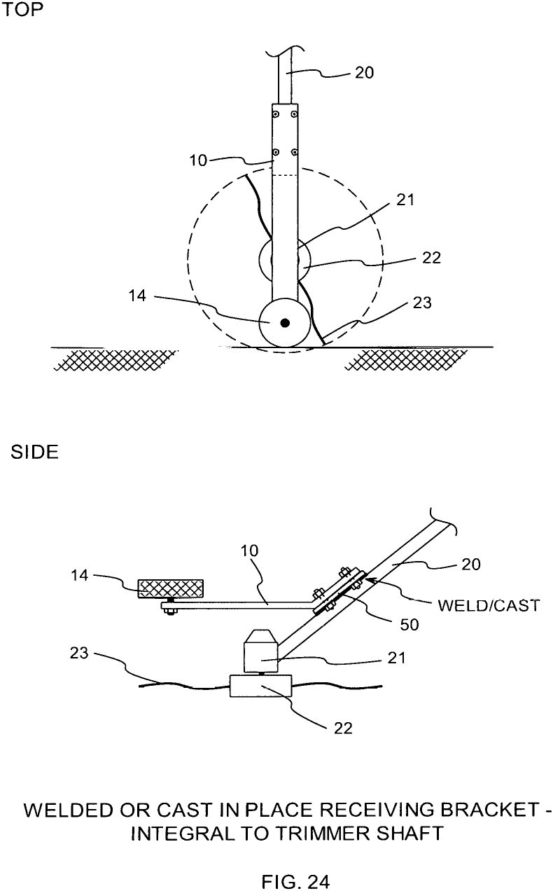

While FIGS. 5A & 5B depicts a side view of string trimmer support retraction option with the clamping device and support arm hinge 24 on the top of the string trimmer shaft 20, other support arm configurations can be used such as a support arm clamped to either side of the string trimmer shaft 20, as shown in FIG. 23, the hinging 24 mechanism could be configured in that arrangement to allow for retracting as well. Spring could be used to maintain retracted and extended positions.

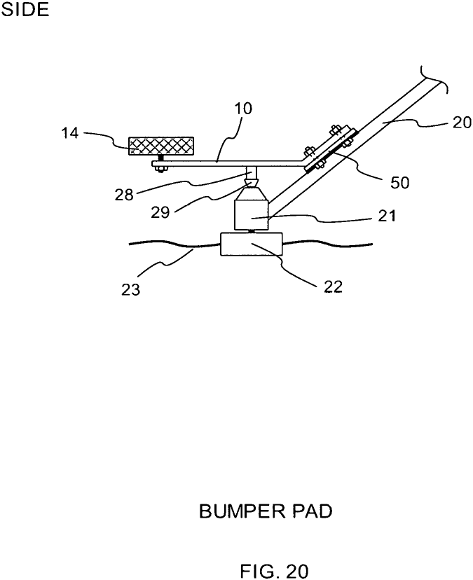

FIG. 20 depicts an example of how the support arm 10 can also be configured to attach a support arm bumper pad bracket 28 connected to a support arm bumper pad 29 between support arm 10 and string trimmer gear case 21 to maintain a set distance between the support arm 10 and the string trimmer gear case 21. The support arm bumper pad bracket 28 can be of various lengths and adjustable.

While preferred material for the string trimmer shaft clip 25, the retracted clip bracket 26, the extended clip bracket 27, the support arm bumper pad bracket 28 anfdthe support arm bumper pad 29 is steel, other metals, metal alloys, plastics and other sufficiently rigid materials could be used.

What is claimed is:

1. A device to support/counteract the forces when edging including the weight of string trimmer, rotational forces of string, impact forces of string to surface impact string trimmer when used as an edging configuration comprised of but not limited to:
a. Clamping apparatus
b. Support Arm
c. Wheel.

2. A device to position the diameter of the string rotation of a string trimmer to maintain proper clearances/distances from objects/surfaces from the rotating string.

3. A device positioned above the string trimmer gear case (opposite the string trimmer string head) to position a wheel in parallel or near parallel plane with the string rotation plane.
